(19) United States
(12) Patent Application Publication
(10) Pub. No.: US 2002/0135133 A1
(43) Pub. Date: Sep. 26, 2002

(54) Sealing unit for the housing of an open-end spinning device

(76) Inventors: Edmund Schuller, Ingolstadt (DE); Dietmar Greis, Ingolstadt (DE)

Correspondence Address: Stephen E. Bondura, Dority & Manning, Attorney at Law, P.A., P.O. Box 1449, Greenville, SC, 29602, US

(21) Appl. No.: 10/045,660

(22) Filed: Jan. 15, 2002

(30) Foreign Application Priority Data
Oct. 23, 2000 (DE) 100 52 528.8

(51) Int. Cl. F16J 15/34

(52) U.S. Cl. 277/377

(57) ABSTRACT

The present invention relates to a sealing unit for the rotor housing of an open-end rotor spinning device with a floatingly supported sealing disk. The invention has its application in particular for the reworking of open-end rotor spinning devices. The sealing unit (1) has a bearing plate (10) with a bore (4) that is surrounded by a sealing rim (11) which interacts with a sealing disk 2. The latter is held on the bearing plate (10) by means of an elastic element (3) and is supported in vertical direction by a stop (5, 32).

The present application relates to a sealing unit for the rotor housing of an open-end rotor spinning device according to the introductory clause of claim 1, in particular for the reworking of an open-end rotor spinning device with a seal for the rotor housing according to the state of the art, e.g. as shown in DE 27 21 385. The seal (15) shown in DE 27 21 385 is designed in the manner of a membrane and is connected via a short cylindrical fixed link to a thickened rim bead 16. This seal is pot-shaped so that the disk 15 is held at an axial distance from the annular collar 19 of the spinning rotor 3. Thereby a chamber 18 is created between the annular collar 19 and the seal, preventing air from entering. The disadvantage of this device is the fact that the spinning rotor must have a salient collar in axial direction in order to achieve a sealing action.

In order to be able to operate such state-of-the-art spinning devices at higher rotational speeds it is necessary to provide a seal of a different type for the rotor housing, interacting e.g. with the shaft of the spinning rotor, because spinning rotors must have a shorter axial collar. In known open-end spinning devices, e.g. of W. Schlaffiorst & Co., the seal of the rotor housing is attached with two element clampingly holding the wall of the rotor housing between them, and the seal is thereby positioned on the rotor housing.

It is the object of the present application to propose a sealing unit for an open-end rotor spinning device by means of which spinning rotor with a smaller collar in axial direction can also be used in state-of-the-art rotor spinning machines, so that the rotor speeds can be increased significantly thanks to the low natural oscillation of such spinning rotors. In addition a low-maintenance sealing unit is to be proposed that requires no difficult means of attachment to the machine.

This object is attained by the invention by means of a sealing unit according to the characteristics of claim 1. As the sealing unit is used in open-end rotor spinning machines, in particular when refitting or modernizing machines already in operation, these machines will be significantly improved. Thereby the rotational speeds of the spinning rotor of the spinning machine can be increased considerably. In addition a significant improvement of the maintenance-friendly characteristic of the machine is achieved, since a worn-out seal can be replaced much more easily and can be replaced by a new one. Furthermore a more reliable sealing of the rotor housing is achieved through the design according to the invention. No work is required to center the seal, as this takes place automatically in its floating support. The vertical support of the sealing disk by means of the stop prevents the sealing disk from falling out even in case that no shaft of a spinning rotor is inserted into the seal. The stop is located especially advantageously on the bearing plate for this or the stop is formed alternatively as a projection on the elastic element to hold the sealing disk.

The bearing plate is advantageously associated with an opposing disk so that secure and adaptable attachment of the sealing unit to the rotor-spinning machine is possible. Thanks to the advantageous design of the bearing plate with a diameter between 35 mm and 75 mm, a universal application of the invention with the most varied spinning machines is made possible. The diameter is most advantageously within a range between 40 mm and 60 mm. Especially in combination with the advantageous dimensions of the bearing plate, the sealing disk is advantageously given a diameter between 34 and 60 mm, preferably between 38 mm and 50 mm and most preferably between 40 mm and 454 mm. The invention is described below through drawings.

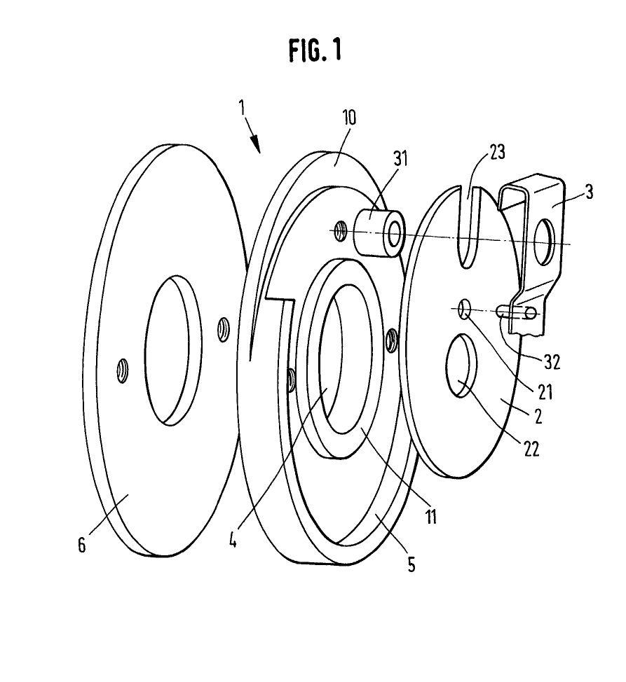

FIG. 1 shows the sealing unit according to the invention as well as the opposing disk 6 interacting with it.

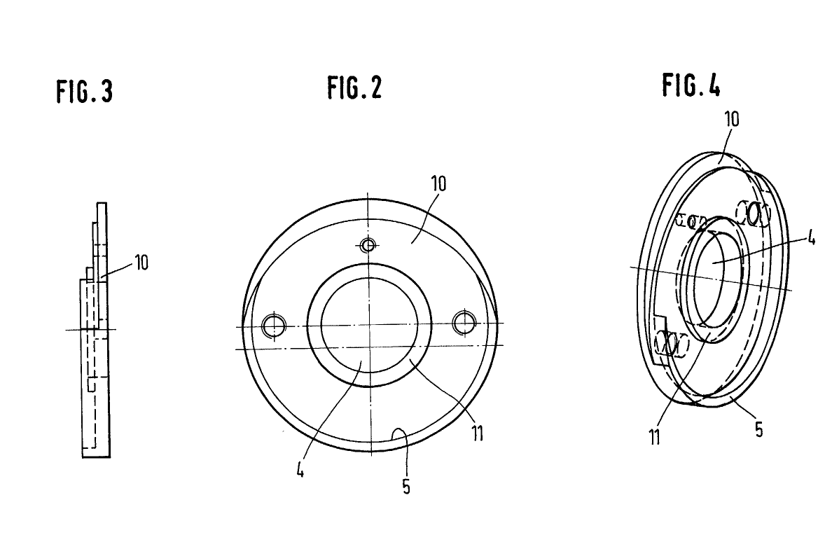

FIGS. 2, 3 and 4 show the bearing plate 10 in different representations: FIG. 2 in a top view, FIG. 3 in a lateral view, and FIG. 4 in a three-dimensional view.

FIG. 1 shows the sealing unit 1 according to the present invention, ,consisting of a bearing plate 10 which supports a sealing disk 2 which is held on the bearing plate 10 by means of an elastic element 3. The sealing disk 2 is applied in that case on the sealing rim 11 of the bearing plate bearing plate 10. the sealing disk 2 is held on the bearing plate 10 by means of the elastic element 3. The elastic element 3 is held by means of an attachment element and a distance-holding bushing 31 and is in turn attached to the bearing plate 10. The plane of the sealing disk 2 is vertical and perpendicular to the shaft (not shown) of a spinning rotor. The sealing disk 2 is provided with the passage bore 22 through which the shaft of the spinning rotor extends during operation. The actual seal between the sealing disk 2 and the shaft of the spinning rotor is achieved by the small gap resulting between the rotor shaft and the limit of the passage bore 22. The floating support of the sealing disk, that is to say the fact that the latter is able to move freely on the sealing rim 11 in its plane at a right angle to the rotor shaft, results in automatic centering of the sealing disk 2 relative to the rotor shaft. An adjustment by the maintenance personnel at the time of installation of the sealing unit 1 is therefore not necessary. Together with the other characteristics of the invention, this renders the sealing unit 1 especially well suited for the refitting of rotor spinning machines and thus for adaptation to the requirements of a modern open-end rotor spinning machine because the installation can also be made on a machine that was not originally intended for it and thus lacks any fitting surfaces or special attachment devices.

The bearing plate 10 has a rim 5 under the bore 4, on which the sealing disk 2 can rest, so that it cannot leave the bearing plate 10 without the elastic element 3 being lifted off by a maintenance worker. The rim 5 advantageously covers 90° to approximately 250° of the circumference of the bearing plate 10. Thanks to the notch 23 which is open all the way to the rim of the sealing disk 2, the sealing disk 2 can be especially advantageously removed from the sealing unit 1 without tools and be reinstalled in it.

The bearing plate 10 interacts with a perforated opposing disk 6 and is screwed to it in the assembled state. The wall of the not-shown housing of the spinning rotor is clampingly held between the opposing disk 6 and the bearing plate 10 so that the proposed sealing unit 1 is fixed on the rotor housing. The opposing disk 6 and the bearing plate 10 are each provided with a perforation the diameter of which is at least able to accept the rotor shaft, but is preferably much larger. The sealing disk 2 on the other hand, only has an opening that is slightly larger than the diameter of the shaft which it encloses tightly to seal it. Since the sealing disk 2 is held via the elastic element on the rim 5 of the bearing plate 10 in such manner as to be capable of being shifted, the rotor shaft (not shown) centers the sealing disk 2 automatically.

By replacing the known seals on rotor housing of the known open-end spinning devices, a better sealing action is achieved, and at the same time a seal is made available that makes it possible to use a rotor whose collar, to which the rotor on the rotor shaft is attached, can be made smaller or can be eliminated entirely, because the seal is on the rotor shaft itself. Thereby the mass of the spinning rotor is considerably lowered, and this makes it possible in state-of-the-art spinning devices to operate them with higher rotor speeds when they have been refitted with a sealing unit 1 according to the invention, because a rotor with a lower mass can be used which has a better oscillation behavior. In addition the sealing action is better, so that the spinning results as well as air consumption of the open-end spinning device are improved.

1. Sealing unit for the rotor housing of an open-end rotor spinning device with a floatingly supported sealing disk, in particular for the reworking of open-end rotors pinning devices, characterized in that the sealing unit (1) is provided with a bearing plate (10) with a bore (4) which is surrounded by a sealing rim (11) that interacts with a sealing disk (2), whereby the sealing disk (2) is held by means of an elastic element (3) on the bearing plate (10), the sealing disk 2 is provided with a passage bore (22) through which a rotor shaft extends, and a stop (5, 32) is provided and constitutes a support of the sealing disk (2) in vertical direction.

2. Sealing unit as in claim 1, characterized in that the support consists of a rim (5) installed on the bearing plate (10).

3. Sealing unit as in claim 1, characterized in that the support is constituted by a projection (32) on the elastic element (3) entering an opening (21) in the sealing disk (2).

4. Sealing unit as in one or several of the claims 1 to 3, characterized in that the bearing plate (10) interacts with a counter-piece, e.g. in form of an opposing disk (6), so that the wall of the housing of an open-end rotor spinning device is held between the two, so that the sealing unit (1) can be attached to the rotor housing.

5. Sealing unit as in one or several of the claims 1 to 4, characterized in that the bearing plate (10) has a diameter between 35 mm and 75 mm.

6. Sealing unit as in claim 5, characterized in that the bearing plate 10 has a diameter between 40 mm and 60 mm.

7. Sealing unit as in one or several of the claims 1 to 6, characterized in that the sealing disk 2 has a diameter between 34 and 60 mm.

8. Sealing unit as in claim 7, characterized in that the sealing disk 2 has a diameter between 38 mm and 50 mm

9. Sealing unit as in claim 8, characterized in that the sealing disk 2 has a diameter between 40 and 45 mm.
